(19) United States
(12) Patent Application Publication
(10) Pub. No.: US 2010/0185652 A1
(43) Pub. Date: Jul. 22, 2010

(54) Multi-Dimensional Resource Fallback

(75) Inventors: Nathan V. Bak, Portland, OR (US); Patricia A. Gaughen, Portland, OR (US); Gerrit Huizenga, Portland, OR (US); Eric B. Munson, Las Cruces, NM (US); Ramachandra N. Pai, Beaverton, OR (US); Timothy C. Pepper, Tigard, OR (US)

Correspondence Address: Lieberman & Brandsdorfer, LLC, 802 Still Creek Lane, Gaithersburg, MD, 20878, US

(73) Assignee: International Business Machines Corporation, Armonk, NY (US)

(21) Appl. No.: 12/355,247

(22) Filed: Jan. 16, 2009

(51) Int. Cl. G06F 7/10; G06F 17/30

(52) U.S. Cl. 707/769; 707/E17.002; 707/E17.055; 707/705

(57) ABSTRACT

A method, system, and article of manufacture are provided for locating a resource in a data structure hierarchy. Data is stored in a hierarchy, such as an objected oriented hierarchy. For each encountered resource that requires data from the hierarchy, identifier and level information is extracted for that resource. A set of resource fallback rules are followed to traverse the hierarchy and to locate a corresponding data item for the subject resource in the hierarchy.

### BACKGROUND OF THE INVENTION

1. Technical Field

This invention relates to storage of multiple instances of a resource. More specifically, the invention pertains to eliminating storage of redundant instances of data in a data structure.

2. Description of the Prior Art

A storage device is a device for recording data. Computer data storage utilizes one or more storage devices to record data. The storage devices may include disks, tapes, disk arrays, tape arrays, flash drives, etc., and any other mechanism capable of non-volatile data storage. It is recognized in the art that storage devices have a finite amount of space for recording data. Accordingly, management of the storage device is critical to ensuring the availability of space for the data intended to be recorded thereon.

It is recognized in the art that software products process data in the form of numbers and integers, and also resources, such as string variables. A string variable is recognized in the art as a series of characters. Some software products contain multiple instances of the same resource, including text or images display to the user during or following execution of the associated program. Each string instance occupies space on an associated storage device. Accordingly, multiple copies of the same resource provide an unnecessary redundancy of data in the limited space of the storage device.

In a similar manner, it is known in the art to translate character strings and other resources into different languages. This provides versatility of a program as it enables users in different countries to take advantage of the same program. Translation memory tools are frequently employed to reduce the cost associated with translating character strings. However, translation memory tools diverge when there are multiple instances of non-identical character strings. The discrepancies of the string usage are compounded with translation of the associated character strings.

Accordingly, there is a need for a tool that mitigates issues pertaining to multiple copies of resources. The tool addresses storage and access to resources and provides convergence of the issues that arise from inconsistency associated with resource usage.

### SUMMARY OF THE INVENTION

This invention comprises a method, system, and article for storing and locating data pertaining to a resource in a hierarchy, such as that used in object oriented programming, having a multi-dimensional resource feedback algorithm.

In one aspect of the invention, a method is provided for locating a resource in a data structure hierarchy. Data is stored in a hierarchy, with the hierarchy being at least a two dimensional hierarchy that includes multiple levels with multiple locales in each class level. In one embodiment, such as an object oriented hierarchy, the level may take the form of a class level. Level information and an identifier are extracted for the resource. The hierarchy is then traversed by applying the extracted determined resource level information and identifier to the hierarchy to locate a corresponding data item for the resource in the hierarchy. A data match of the resource is returned from the hierarchy in response to a match of both the level and the identifier of the resource with a data item stored in the hierarchy.

In another aspect of the invention, a computer system is provided with a processor unit in communication with data storage and hierarchically stored data. The hierarchy is at least a two dimensional hierarchy that includes multiple levels with multiple locales in each class level. A resource manager is provided in communication with the hierarchy. The resource manager extracts identifier and level information for the resource. In addition, a data location manager is provided in communication with the resource manager. The data location manager traverses the hierarchy, through application of the extracted resource level information and identifier to the hierarchy, to locate a corresponding data item for the resource in the hierarchy. A data match of the resource is returned from the hierarchy in response to a match of both the level and the identifier of the resource with a data item stored in the hierarchy.

In yet another aspect of the invention, an article is provided with a computer readable carrier including computer program instructions configured to traverse the hierarchy. Instructions are provided to locate data in the hierarchy. The hierarchy is at least a two dimensional hierarchy that includes multiple levels with multiple locales in each level. Instructions are also provided to extract identifier and level information for the resource and to traverse the hierarchy. The traversal instructions apply the extracted resource level information and identifier to the hierarchy to locate a corresponding data item for the resource in the hierarchy. A data match of the resource is returned from the hierarchy responsive to a match of both the class level and the identifier of the resource with a data item stored in the hierarchy.

Other features and advantages of this invention will become apparent from the following detailed description of the presently preferred embodiment of the invention, taken in conjunction with the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention unless otherwise explicitly indicated. Implications to the contrary are otherwise not to be made.

FIG. 1 is a block diagram of a prior art object hierarchy for storing data.

FIG. 2 is a block diagram of an example data structure in the form of an object oriented hierarchy that is structured to accommodate character string translations between English and French.

FIG. 3 is a flow chart demonstrating a process for traversing a two dimensional hierarchal structure of nodes for displaying a character string.

FIG. 4 is a block diagram illustrating placement of managers in a computer system to facilitate identifying and locating a resource in a hierarchical data structure according to the preferred embodiment of this invention, and is suggested for printing on the first page of the issued patent.

### DESCRIPTION OF THE PREFERRED EMBODIMENT

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

The functional units described in this specification have been labeled as managers, including a resource manager and a data location manager. A manager may be implemented in programmable hardware devices such as field programmable gate arrays, programmable array logic, programmable logic devices, or the like. The manager may also be implemented in software for execution by various types of processors. An identified manager of executable code may, for instance, comprise one or more physical or logical blocks of computer instructions which may, for instance, be organized as an object, procedure, function, or other construct. Nevertheless, the executables of an identified manager need not be physically located together, but may comprise disparate instructions stored in different locations which, when joined logically together, comprise the manager and achieve the stated purpose of the manager.

Indeed, a manager of executable code could be a single instruction, or many instructions, and may even be distributed over several different code segments, among different applications, and across several memory devices. Similarly, operational data may be identified and illustrated herein within the manager, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of traversing a data structure by applying extracted resource information to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

### Overview

The method, apparatus, and article of manufacture of the present invention provides valuable advantage over the prior art. According to the present invention, there is no redundancy of data items stored in the data structure. This provides uniformity associated with the data items sought from the data structure. Similarly, a set of rules are employed to logically traverse the data structure. As a resource is encountered, the level and associated identifier are extracted from the resource. The extracted data is then employed with the rules to traverse the data structure for an associated data item. In one embodiment, the local information is extracted from the resource and employed together with the extracted class level and/or identifier to traverse the data structure.

### Technical Details

In the following description of the embodiments, reference is made to the accompanying drawings that form a part hereof, and which shows by way of illustration the specific embodiment in which the invention may be practiced. As one skilled in the art would recognize, a hierarchy is an embodiment of the computer science concept of a tree where classes are organized into hierarchies or trees. Conceptually, the classes can be thought of as nodes in the tree, and a “class level” is identified as a node height within a tree. It is to be understood that other embodiments may be utilized because structural changes may be made without departing form the scope of the present invention.

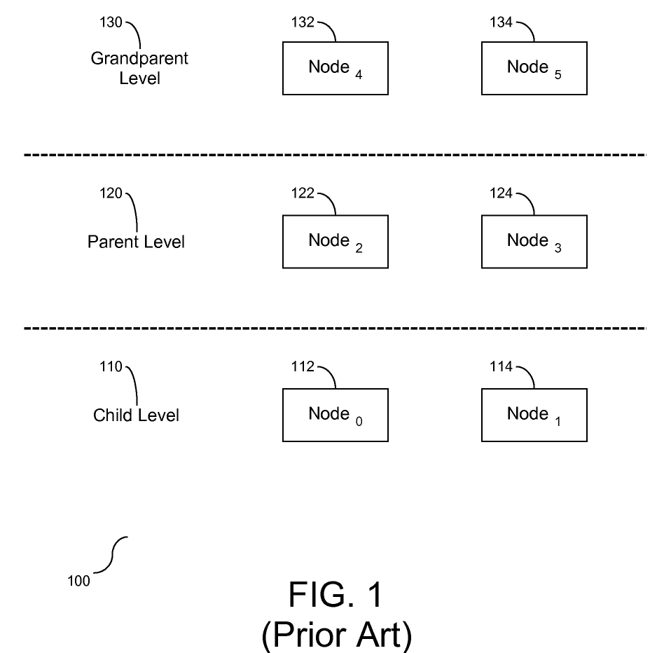

A data structure hierarchy is employed to organize a collection of data. FIG. 1 is a block diagram (100) of a prior art hierarchy for storing data. As shown in the diagram, there are three levels of the hierarchy. A first level is known as a child level (110); a second level is known as a parent level (120); and a third level is known as a grandparent level (130). Although only three levels of the hierarchy are shown herein, the invention should not be limited to this quantity of levels in the hierarchy. In one embodiment, the hierarchy may include a greater or lower number of levels. Each level in the hierarchy shown herein includes two nodes. Although only two nodes are shown in each level of the hierarchy, the invention should not be limited to this quantity of nodes. In one embodiment, one or more of the levels in the hierarchy may include a fewer or greater number of nodes. As shown by way of example, the child level (110) has Node₀ (112) and Node₁ (114); the parent level (120) has Node₂ (122) and Node₃ (124); and the grandparent level (130) has Node₄ (132) and Node₅ (134). Accordingly, the hierarchy includes multiple tiers with multiple nodes in each tier of the hierarchy.

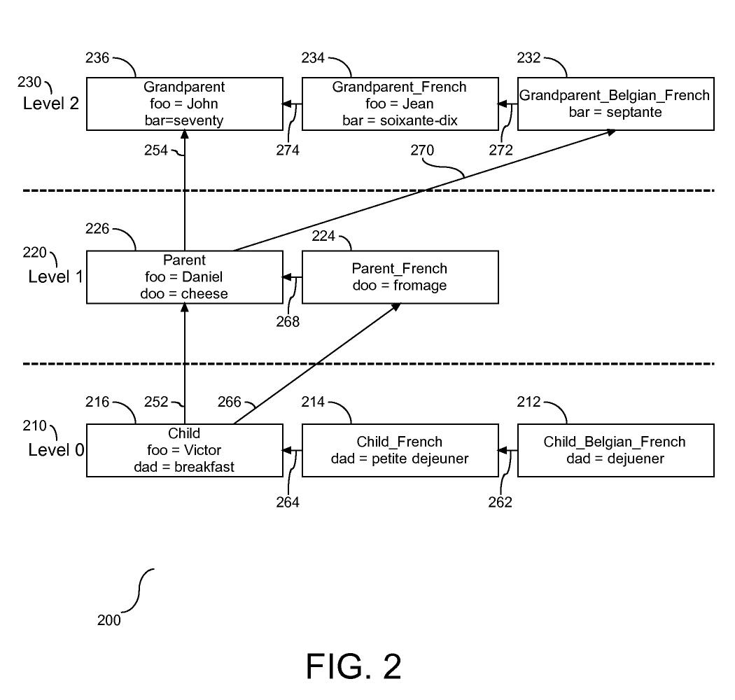

In one embodiment, the data in the hierarchy may be in the form of character strings. For purposes of description, the data examples shown herein will be described pertaining to character strings of two languages, English and French, with the French having some Belgian French derivatives. However, the invention should not be limited to translation between two languages or the languages described herein. In one embodiment, alternative languages may be substituted for the languages described herein, as well as an expansion of the hierarchy to accommodate additional languages. FIG. 2 is a block diagram (200) of an example data structure in the form of a hierarchy that is structured to accommodate character string translations between English and French. As shown, there are three levels, also knows as tiers, in the hierarchy Level₀ (210), Level₁ (220), and Level₂ (230). Each level includes two or three nodes. More specifically, the child level, Level₀, (210) includes nodes (212), (214), and (216); the parent level, Level₁, (220) includes nodes (224) and (226); and the grandparent level, Level₂, (230) includes nodes (232), (234), and (236). Each node in each level of the hierarchy pertains to one of the languages available for string translations. More specifically, child node (212) is shown storing translation of one English language word into Belgian French; child node (214) is shown storing translation of one English language word into French; parent node (224) is shown storing translation of an English language word into French; grandparent node (232) is shown storing translation of an English language word into Belgian French; and grandparent node (234) is shown storing translations of two English language words into French. Each translation is only stored once in the hierarchy. There is no repetition of translations. In the example shown herein, the child node (212) stores the translation of an English language word found in child node (216) in Belgian French and child node (214) stores the translation of the same English word in French; the parent node (224) storing a French translation of the same English language word found in parent node (226); and the grandparent node (232) storing translation of the one grandparent node (236) English language word in Belgian French, and two French translations are found in grandparent node (234). Although different terms may be represented in the hierarchy, each unique word represented in the hierarchy has only a single translation. Accordingly, the organization of the hierarchy supports a single entry of unique each data item in the hierarchy.

In a similar manner, as shown in FIG. 2, there are English nodes in each level of the hierarchy, namely, child node (216), parent node (226), and grandparent node (236). As shown, child node (216) has two translatable character strings. Similarly, parent node (226) and grandparent node (236) also include two translatable character strings. As shown, one of the two translatable character strings in node (236) is the same as that shown in parent node (226) and child node (216), but with different values. Accordingly, there is no repetition of translatable character strings in the hierarchical representation of the data structure.

As shown in FIG. 2, there are lines that interconnect the different nodes in the hierarchy. There are two formats for the lines, a first format is a solid line representation, and a second format is a dotted line representation. The solid lines (252) and (254) show the English language traversal of the hierarchy. Conversely, the dotted lines (262), (264), (266), (268), (270), (272), and (274) show the Belgian French language traversal of the hierarchy. The procession of the arrows through the hierarchy is also known as the fallback. The procession of the arrows shown herein is merely one embodiment of how the hierarchy of the data structure may be traversed. The order of the procession may be modified based upon rules applied to the data structure. In one embodiment, these rules are known as fallback rules. Accordingly, the processing of the data structure shown herein is one embodiment of how the nodes and associated hierarchy are traversed.

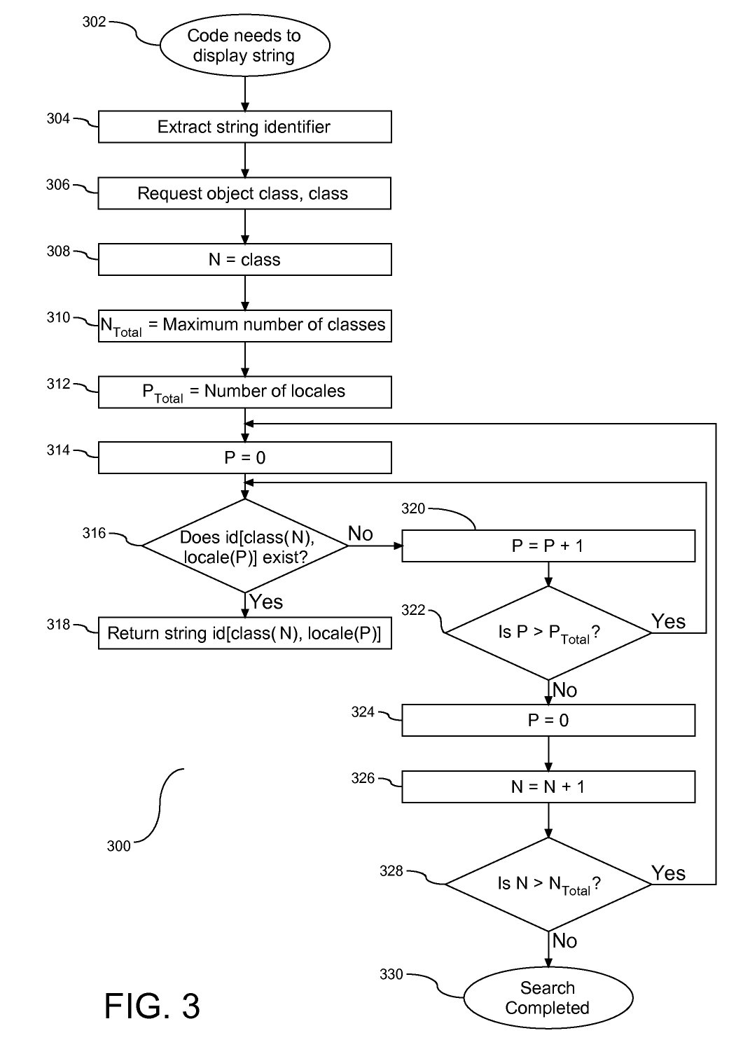

FIG. 3 is a flow chart (300) demonstrating a process for traversing a two dimensional hierarchal structure of nodes for displaying a character string. In one embodiment, the aspect of displaying a character string may be extrapolated to include translation of the encountered string as demonstrated in FIG. 2 above. As shown, the source code encounters a resource that needs to display a string (302). In response to the encounter, an identifier of the encountered resource is extracted (304), as well as class level information for the resource (306). The variable N is assigned to the extracted class level (308). The class level of the resource represents the level in the hierarchy of the data structure. There is a finite quantity of class levels in the hierarchy, and the variable N_{Total} is assigned to the value of the maximum quantity of levels in the hierarchy of the data structure (310), with each level having at least one locale therein. The variable P_{Total} is assigned to the maximum number of locales in each class level in the hierarchy (312). Prior to traversing the hierarchy to find the corresponding data item for the encountered resource, a counting variable, P, for the locale of the encountered resource is set to zero (314). Following step (314), it is determined if the encountered resource at class level (N) and locale (P) exists in the hierarchy of the data structure (316). The data item for the encountered resource at class (N) and locale (P) is returned if the determination is positive (318). However, in response to a negative determination at step (318), the variable P is incremented (320), followed by a determination as to whether the incremented value of P exceeds the maximum number of locales in the class level (322). A positive response to the determination at step (322) is followed by a return to step (316). Accordingly, the steps demonstrated herein illustrate traversal of each local in one class level in the hierarchical data structure.

If following step (322) it is determined that the encountered resource is not present in the hierarchy level N, then the variable P is reset (324) and the variable N associated with the class level is incremented (326). The increment of the variable N enables the search to proceed to the next class level of the data structure hierarchy and each of the locales therein, as represented by the resetting of the variable P. Thereafter, it is determined if there is a next class level in the hierarchy (328). In other words, has the traversal concluded each of the hierarchical class levels of the data structure. A positive response to the determination at step (328) is followed by a conclusion of the data structure search without a return of a data match for the encountered resource (330). Conversely, a positive response to the determination at step (328) is followed by a return to step (314). Accordingly, as demonstrated herein, each class level within the hierarchy is searched for a data match of an encountered resource.

As demonstrated in FIG. 3, the hierarchical data structure only needs to store each data item in one location in the hierarchy. With respect to an embodiment that addresses character string translations, each character string only has to have a single translation stored in one locale in the data structure. Each locale in the hierarchy can have multiple character strings, or no character strings. Furthermore, FIG. 3 is a demonstration of one aspect of traversing the hierarchy of a data structure. However, the invention should not be limited to this traversal. In one embodiment, the instructions for traversing the data structure are set by the programmer. Similarly, in one embodiment the instructions for traversing the data structure may change dynamically. The traversal instructions provide a map for searching the data structure for a data item. Different sets of traversal instructions may be provided, wherein the underlying commonality is that the data structure not store multiple copies of the same character string. As shown herein, the class level information is extracted from the encountered resource. In one embodiment, an identifier associated with the encountered resource is extracted and employed together with the extracted class level and locale to locate a corresponding data item in the hierarchy. Accordingly, the instructions for searching a data structure as demonstrated herein should not be limited to the specific embodiment shown in FIG. 3, as the instructions may vary.

In one embodiment, the invention is implemented in software, which includes but is not limited to firmware, resident software, microcode, etc. The invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

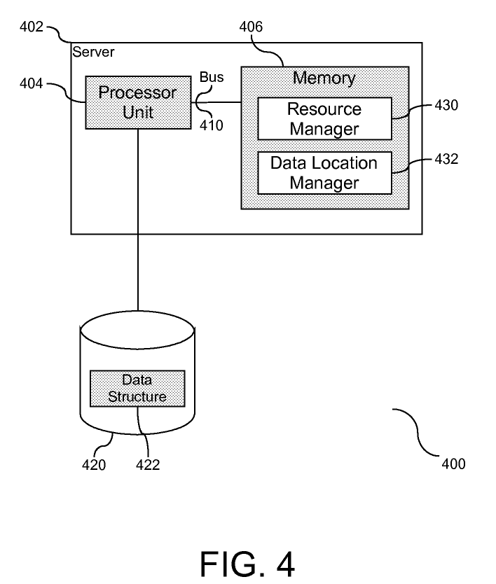

FIG. 4 is a block diagram (400) illustrating placement of managers in a computer system to facilitate identifying and locating a resource in a hierarchical data structure. The illustration shows a server (402) with a processing unit (404) coupled to memory (406) by a bus structure (410). Although only one processor unit (404) is shown, in one embodiment, the server (402) may include more processor units in an expanded design. As shown in FIG. 4, the server (402) is in communication with data storage (420), which may include a plurality of storage devices. Although only two storage devices (420) are shown herein, the invention should not be limited to the quantity of storage devices illustrated. The data storage (420) is employed to store data in an object oriented hierarchy. In one embodiment, a data structure (422) is maintained on the data storage (420). The data structure is at least a two dimensional hierarchy that includes multiple class levels with multiple locales in each class level.

In order to efficiently traverse the data structure to locate a resource therein, a set of managers are provided in communication with the data storage. A resource manager (430) and a data location manager (432) are both shown residing in memory (406) of the server (402). The resource manager (430) is employed to extract identifier and class level information for the encountered resource. The data location manager (432) is employed to traverse the data structure to locate a corresponding data item for the encountered resource. In one embodiment, the data location manager employs both the extracted class level information and the extracted identifier for locating the data item.

Although the managers (430) and (432) are shown residing in memory (406), the invention should not be limited to this embodiment. In one embodiment, the managers (430) and (432) may individually or in combination reside as hardware tools external to memory (406), or they may be implemented as a combination of hardware and software tools. Accordingly, the managers (430) and (432) may be implemented as software or hardware tools to facilitate extraction of resource identification information and traversal of the data structure.

Embodiments within the scope of the present invention also include articles of manufacture comprising program storage means having encoded therein program code. Such program storage means can be any available media which can be accessed by a general purpose or special purpose computer. By way of example, and not limitation, such program storage means can include RAM, ROM, EEPROM, CD-ROM, or other optical disk storage, magnetic disk storage or other magnetic storage devices, or any other medium which can be used to store the desired program code means and which can be accessed by a general purpose or special purpose computer. Combinations of the above should also be included in the scope of the program storage means.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, random access memory (RAM), read-only memory (ROM), a rigid magnetic disk, and an optical disk. Current examples of optical disks include compact disks, read only (CD-ROM), compact disk read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks.

The software implementation can take the form of a computer program product accessible from a computer-useable or computer-readable medium providing program code for use by or in connection with a computer or any instruction execution system.

### Advantages Over the Prior Art

Data is organized in a hierarchy together with a set of resource fallback rules that limits the quantity of data items retained in the data structure. A single version of each resource is retained in the data structure. When applying string translations to the resources in the hierarchy, both product size and translation costs are reduced. In addition, resources are synchronized by the uniformity of providing a single translation for the resource. There is no requirement to duplicate data items. This eliminates discrepancies associated with multiple conflicting or confusing data items.

### Alternative Embodiments

It will be appreciated that, although specific embodiments of the invention have been described herein for purposes of illustration, various modifications may be made without departing from the spirit and scope of the invention. In particular, the aspect of traversing the data structure as demonstrated in FIG. 3 is also known as a resource fallback based upon a defined set of rules. In one embodiment, the rules may be modified to employ an alternative resource fallback mechanism. The rules can be defined or determined at various times, including at the time of coding, compilation of the code, run time, or any combination of such times. Furthermore, the hierarchy shown herein employs a two dimensional hierarchy. In one embodiment, the hierarchy may be expanded to a three dimensional hierarchy, or a hierarchy with a greater number of dimensions. The data structure hierarchy employed may be an object oriented hierarchy, but is not limited to this specific hierarchy structure. Accordingly, the scope of protection of this invention is limited only by the following claims and their equivalents.

We claim:

1. A method for locating a resource in a data structure hierarchy, comprising:
storing data in a hierarchy, wherein the hierarchy is at least a two dimensional hierarchy that includes multiple levels with multiple locales in each level;
extracting an identifier and class level information for the resource;
traversing the hierarchy by applying the extracted determined resource level information and identifier to the hierarchy to locate a corresponding data item for the resource in the hierarchy;
returning a data match of the resource from the hierarchy responsive to a match of both the level and the identifier of the resource with a data item stored in the hierarchy.

2. The method of claim 1, further comprising extracting locale information for the resource, and applying the locale information in combination with the extracted level and identifier information to locate the corresponding data item in the hierarchy.

3. The method of claim 2, wherein the step of extracting locale information is conducted external to the resource.

4. The method of claim 3, further comprising determining locale information from the operating system in communication with the resource.

5. The method of claim 1, wherein each unique data item stored in the hierarchy is limited to a single representation in a single level and locale in the hierarchy.

6. The method of claim 1, wherein the step of extracting class information for the resource includes applying code introspection to the resource.

7. The method of claim 1, wherein a data items is selected from the group consisting of: translation of a character string, sound, an icon, a graphic, an animation, a calendar, a video, an object, metadata, and combinations thereof.

8. A computer system, comprising:
a processor unit in communication with data storage;
data stored in a hierarchy in the data storage, wherein the hierarchy is at least a two dimensional hierarchy that includes multiple levels with multiple locales in each level;
a resource manager in communication with the hierarchy, the resource manager to extract an identifier and class level information for the resource;
a data location manager in communication with the resource manager, the data location manager to traverse the hierarchy through application of the extracted resource level information and identifier to the hierarchy to locate a corresponding data item for the resource in the hierarchy;
a data match of the resource returned from the hierarchy in response to a match of both the level and the identifier of the resource with a data item stored in the hierarchy.

9. The system of claim 8, further comprising the resource manager to extract locale information for the resource, and apply the locale information in combination with the extracted level and identifier information to locate the corresponding data item in the hierarchy.

10. The system of claim 9, wherein the extraction of the locale information by the resource manager is conducted external to the resource.

11. The system of claim 10, further comprising the resource manager to determine locale information from the operating system in communication with the resource.

12. The system of claim 8, wherein each unique data item stored in the hierarchy is limited to a single representation in a single level and locale in the hierarchy.

13. The system of claim 8, wherein the resource manager applies code introspection to the resource to extract class information.

14. The system of claim 8, wherein a data items is selected from the group consisting of: translation of a character string, sound, an icon, a graphic, an animation, a calendar, a video, an object, metadata, and combinations thereof.

15. An article configured to locate a resource in a data structure hierarchy, the article comprising:
a computer readable carrier including computer program instructions configured to traverse the hierarchy, the instructions comprising:
instructions to store data in a hierarchy, wherein the hierarchy is at least a two dimensional hierarchy that includes multiple levels with multiple locales in each level;
instructions to extract an identifier and level information for the resource; and
instructions to traverse the hierarchy by applying the extracted determined resource level information and identifier to the hierarchy to locate a corresponding data item for the resource in the hierarchy; and
a data match of the resource returned from the hierarchy responsive to a match of both the level and the identifier of the resource with a data item stored in the hierarchy.

16. The article of claim 1, further comprising instructions to extract locale information for the resource, and apply the locale information in combination with the extracted level and identifier information to locate the corresponding data item in the hierarchy.

17. The article of claim 16, wherein the instructions to extract locale information is conducted external to the resource.

18. The article of claim 17, further comprising instructions to determine locale information from the operating system in communication with the resource.

19. The article of claim 15, wherein each unique data item stored in the hierarchy is limited to a single representation in a single level and locale in the hierarchy.

20. The article of claim 15, wherein the instructions to extract class information for the resource includes applying code introspection to the resource.
